(19) United States
(12) Patent Application Publication
(10) Pub. No.: US 2012/0061381 A1
(43) Pub. Date: Mar. 15, 2012

(54) INDUCTION COOKING DEVICE

(75) Inventors: Takuya Hashimoto, Hyogo (JP); Kenji Watanabe, Nara (JP); Shintaro Noguchi, Hyogo (JP); Taizo Ogata, Hyogo (JP)

(73) Assignee: PANASONIC CORPORATION, Kadoma-shi, Osaka (JP)

(21) Appl. No.: 13/321,630

(22) PCT Filed: Feb. 25, 2010
(86) PCT No.: PCT/JP2010/001265

§ 371 Date: Nov. 21, 2011

(30) Foreign Application Priority Data
Jun. 1, 2009 (JP) 2009-131742

(51) Int. Cl. H05B 6/12

(52) U.S. Cl. 219/620

(57) ABSTRACT

First material discriminating unit for comparing a magnitude of an input current to inverter circuit and a magnitude of a heating coil current to discriminate a material of cooking container between a non-magnetic body and a magnetic body; second material discriminating unit for comparing a magnitude of the heating coil current and an ON time of switching element when discriminated as the magnetic body by first material discriminating unit to discriminate the material of cooking container as magnetic SUS or iron are arranged, where control unit sets a control temperature lower when the material is discriminated as magnetic SUS by second material discriminating unit than when the material is discriminated as iron so that the temperature of cooking container can be controlled to a predetermined temperature at high accuracy even if cooking container is configured by magnetic SUS, similar to when configured by iron.

### TECHNICAL FIELD

The present invention relates to an induction cooking device, used in a general household kitchen or the like, for carrying out temperature control of a cooking container using an infrared sensor.

### BACKGROUND ART

Conventionally, this type of induction cooking device includes a top plate for placing a cooking container, a heating coil for inductively heating the cooking container, an inverter circuit for supplying high frequency current to the heating coil, a temperature detection unit for detecting the temperature of an object to be heated with the amount of radiant energy of the object to be heated, and a material discriminating unit for discriminating the material of the cooking container mounted on the top plate. The material of the cooking container is discriminated as aluminum, non-magnetic stainless steel (hereinafter referred to as non-magnetic SUS, magnetic stainless steel (hereinafter referred to as SUS), or iron from the relationship of an input current flowing to the inverter circuit and a heating coil current flowing to the heating coil by the material discriminating unit. If the discriminated material is iron, the temperature of the cooking container is maintained at a predetermined temperature (see e.g., patent document 1) with no different from the case of the magnetic SUS and the case of the iron by correcting the control temperature for controlling the temperature of the cooking container high compared to when the discriminated material is a magnetic stainless steel (see e.g., patent document 1).

However, it is difficult to discriminate the case in which the cooking container is configured by magnetic SUS and the case in which the cooking container is configured by iron since the relationship of the input current and the heating coil current is similar for when the material of the cooking container is magnetic SUS and iron in the induction cooking device configured as above.

The cooking container for induction cooking device includes that in which a plate of magnetic SUS including a plurality of holes is pressure welded to the outer side of a bottom surface of the main body of the cooking container made of non-magnetic body such as aluminum. As the non-magnetic body enters the plurality of holes of the magnetic SUS plate, it is difficult to discriminate such type of magnetic SUS and iron. Therefore, in the fried food cooking where accuracy in temperature adjustment is demanded, discrimination of magnetic SUS (include pressure welding configuration) and iron is difficult, and hence the cooking can be carried out at an appropriate temperature only with the cooking container of a specific material.
PTL 1 Unexamined Japanese Patent Publication No. 2005-078993

### SUMMARY OF THE INVENTION

The present invention provides an induction cooking device capable of appropriately discriminating between magnetic SUS and iron when the material of the cooking container is a magnetic body, and controlling the temperature of the cooking container to a predetermined temperature at high accuracy in fried food cooking or the like where accuracy in temperature adjustment is demanded.

The present invention includes an inverter circuit, including a heating coil for inductively heating a cooking container, a resonance capacitor configuring a resonance circuit with the heating coil, and a switching element, for supplying a heating coil current corresponding to an ON time of the switching element to the heating coil; and an infrared sensor for detecting infrared light radiated from a bottom surface of the cooking container. The present invention also includes a first material discriminating unit for discriminating a material of the cooking container between a non-magnetic body and a magnetic body; a second material discriminating unit for discriminating the material of the cooking container between magnetic SUS and iron; and a control unit for controlling a magnitude of an output of the inverter circuit by changing the ON time of the switching element to carry out control so that a detection temperature of the infrared sensor becomes a predetermined control temperature, and setting the control temperature lower when the material is discriminated as magnetic SUS than when the material is discriminated as iron based on determination results of the first material discriminating unit and the second material discriminating unit. Furthermore, in the present invention, the control unit has a configuration of comparing a magnitude of the heating coil current and the ON time of the switching element in a case where a heating output is set to a predetermined value, and discriminating the material of the cooking container as iron if the ON time of the switching element and the magnitude of the heating coil current are within a predetermined region and discriminating the material of the cooking container as magnetic SUS if the ON time of the switching element and the magnitude of the heating coil current are outside the predetermined region.

According to such configuration, magnetic SUS and iron can be appropriately discriminated when the material of the cooking container is a magnetic body, and the temperature of the cooking container can be controlled to a predetermined temperature at high accuracy, similar to the case of iron, even when the material is magnetic SUS.

### BRIEF DESCRIPTION OF THE DRAWINGS

FIG. 1 is a block diagram of an induction cooking device according to a first exemplary embodiment of the present invention.

FIG. 2 is a circuit diagram showing an inverter circuit according to the first exemplary embodiment of the present invention.

FIG. 3 is a diagram describing a first material discriminating unit according to the first exemplary embodiment of the present invention.

FIG. 4 is a diagram describing a second material discriminating unit according to the first exemplary embodiment of the present invention.

FIG. 5 is a diagram describing a temperature set value by the material of the cooking container according to the first exemplary embodiment of the present invention.

FIG. 6 is a circuit diagram showing an inverter circuit of an induction cooking device according to a second exemplary embodiment of the present invention.

FIG. 7 is a connection diagram of an inverter circuit of an induction cooking device according to a third exemplary embodiment of the present invention.

FIG. 8 is a connection diagram of an inverter circuit of an induction cooking device according to a fourth exemplary embodiment of the present invention.

FIG. 9 is a connection diagram of an inverter circuit of an induction cooking device according to a fifth exemplary embodiment of the present invention.

### DETAILED DESCRIPTION OF THE PREFERRED EMBODIMENTS

Hereinafter, an induction cooking device of the present invention will be described with reference to the drawing based on the exemplary embodiments. The present invention is not limited to such exemplary embodiments.

### First Exemplary Embodiment

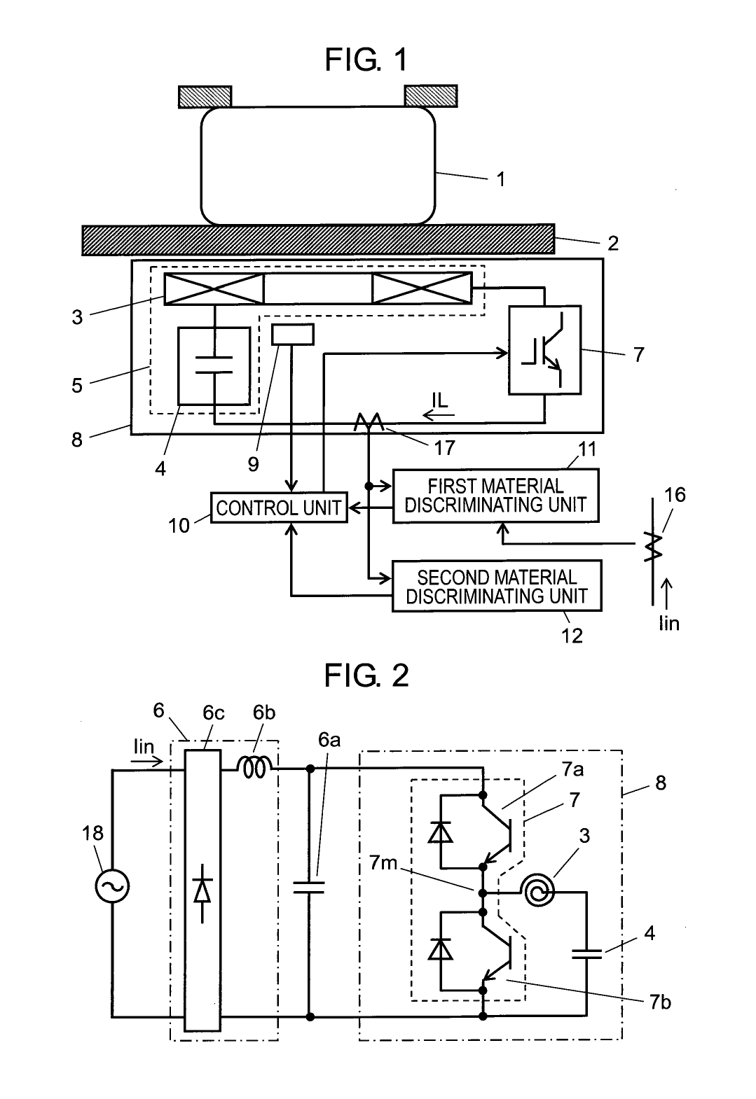

In FIG. 1, an induction cooking device of the present exemplary embodiment includes top plate 2, formed with crystallized ceramic material having heat resistance that transmits light, for mounting cooking container 1, heating coil 3, arranged under top plate 2, for induction heating cooking container 1, and resonance capacitor 4 configuring a resonance circuit with heating coil 3. For instance, heating coil 3 and resonance capacitor 4 are connected in series to configure resonance circuit 5.

Furthermore, the induction cooking device of the present exemplary embodiment has inverter circuit 8 including resonance circuit 5 and switching element section 7. Switching element section 7 includes a plurality of switching elements (not shown) that are connected in series and are exclusively turned ON at a predetermined duty. Inverter circuit 8 supplies heating coil current IL corresponding to the ON time of the switching element configuring switching element section 7 (hereinafter simply referred to as ON time of switching element section 7) to heating coil 3.

The induction cooking device of the present exemplary embodiment includes first material discriminating unit 11 for comparing a magnitude of input current Iin to inverter circuit 8 detected by current transformer 16, which is an input current detection unit, and a magnitude of heating coil current IL detected by current transformer 17, which is a heating coil current detection unit, to discriminate the material of cooking container 1 between non-magnetic body and magnetic body. As shown in FIG. 2, input current Iin may measure the input current of rectifier 6c, or may measure the current or the voltage of a portion in a proportional relationship with input current Iin.

Furthermore, the induction cooking device of the present exemplary embodiment includes second material discriminating unit 12 for comparing the magnitude of heating coil current IL and the ON time of switching element section 7, discriminating the material of cooking container 1 as iron if the magnitude of heating coil current IL is within a predetermined region with respect to the ON time of switching element section 7, and then discriminating the material of cooking container 1 as magnetic SUS if the magnitude of heating coil current IL is outside a predetermined range with respect to the ON time of switching element section 7.

Furthermore, the induction cooking device of the present exemplary embodiment includes infrared sensor 9 for detecting an infrared light radiated from a bottom surface of cooking container 1 and transmitted through top plate 2, and control unit 10 for controlling the magnitude of the output of inverter circuit 8 by outputting a drive signal to switching element section 7 to control the detection temperature of infrared sensor 9 to a predetermined control temperature, and setting the control temperature lower when the material is discriminated as magnetic SUS than when the material is discriminated as iron based on the determination result of first material discriminating unit 11 and second material discriminating unit 12.

FIG. 2 is a circuit diagram of the inverter circuit in the present exemplary embodiment. In FIG. 2, direct current (DC) power supply 6 is configured by rectifier 6c for inputting and full-wave rectifying commercial power supply 18, choke coil 6b having one end connected to a positive terminal of rectifier 6c, and smoothing capacitor 6a connected between an output terminal of choke coil 6b and a negative terminal of rectifier 6c, and outputs a DC voltage of a pulsating flow to inverter circuit 8. Inverter circuit 8 includes a series circuit including first switching element 7a on a high potential side and second switching element 7b on a low potential side connected in series, where both ends of the series circuit including first switching element 7a and second switching element 7b are connected between DC power supplies 6. First switching element 7a and second switching element 7b configure switching element section 7 of FIG. 1. One end of resonance circuit configured by heating coil 3 and resonance capacitor 4 is connected to connecting point 7m of first switching element 7a and second switching element 7b. The other end of resonance circuit 5 is connected to low potential side of second switching element 7b. The other end of resonance circuit 5 may be connected to high potential side of first switching element 7a.

Control unit 10 exclusively and alternately conducts first switching element 7a and second switching element 7b at a constant frequency, and controls the output by a ratio of an ON time and an OFF time of first switching element 7a and second switching element 7b to control the output such that a temperature obtained from infrared sensor 9 becomes a predetermined control temperature. Control unit 10 may drive first switching element 7a and second switching element 7b not with a constant frequency but with a different frequency, and control the output of inverter circuit 8. Control unit 10 may combine the output control by the ratio of the ON time and the OFF time of first switching element 7a and second switching element 7b with a constant frequency, and the output control carried out with the ratio of the ON time and the OFF time fixed and the frequency changed.

First material discriminating unit 11 compares the magnitude of input current Iin of inverter circuit 8 and the magnitude of heating coil current IL to discriminate the material of cooking container 1 between non-magnetic body or magnetic body.

Second material discriminating unit 12 discriminates the material as iron when heating coil current IL in a case where the heating output is set to a predetermined value and ON time Ton of first switching element 7a or second switching element 7b are within a predetermined region when first material discriminating unit 11 discriminates the material of cooking container 1 as the magnetic body, and discriminates the material as the magnetic SUS if not within the predetermined region.

Second material discriminating unit 12 discriminates as iron when ON time Ton of first switching element 7a or second switching element 7b is smaller than first predetermined value, and discriminates as magnetic SUS in other cases. As shown with line A in FIG. 4, discrimination can be more accurately carried out if a first predetermined value is changed according to heating coil current IL. In other words, the first predetermined value may be changed in proportion to heating coil current IL until ON time Ton of first switching element 7a or second switching element 7b becomes predetermined ON time Ton1.

Second material discriminating unit 12 discriminates as iron when ON time Ton of first switching element 7a or second switching element 7b is smaller than the first predetermined value, and heating coil current IL is a predetermined value smaller than second predetermined value, and discriminates as magnetic SUS of pressure welding configuration to be described below in other cases. As shown with line B in FIG. 4, discrimination can be more accurately carried out if the second predetermined value is changed according to ON time Ton of first switching element 7a or second switching element 7b. In other words, the second predetermined value may be changed in proportion to ON time Ton of first switching element 7a or second switching element 7b until heating coil current IL becomes predetermined heating coil current IL1.

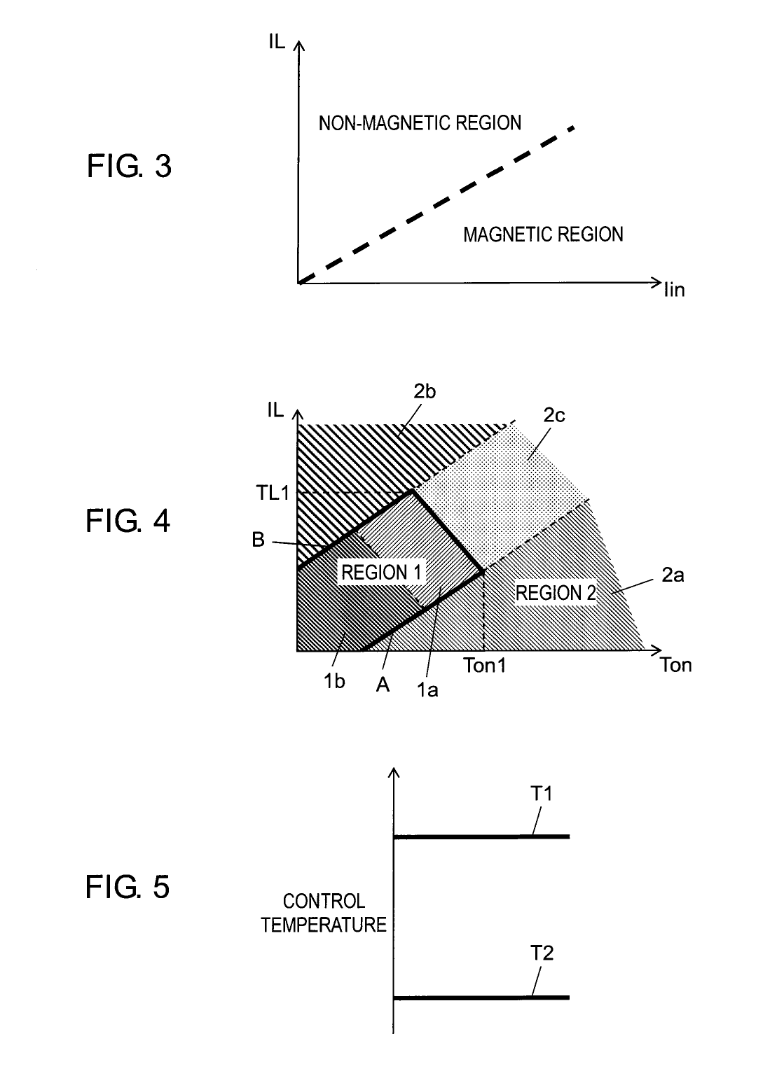

The operation of the induction cooking device configured as above will be described below. FIG. 3 is a diagram describing the first material discriminating unit in the present exemplary embodiment. First material discriminating unit 11 compares the magnitude of input current IL to inverter circuit 8 and the magnitude of heating coil current IL to discriminate whether the material of cooking container 1 is a non-magnetic body or a magnetic body after starting heating. In the relationship of input current Iin and heating coil current IL shown with a dotted line in FIG. 3, the material of cooking container 1 is discriminated as non-magnetic body if a predetermined or greater heating coil current IL is obtained with respect to predetermined input current Iin, and discriminated as magnetic body if heating coil current IL is smaller than a predetermined heating coil current.

First material discriminating unit 11 merely need to be able to detect at least whether the material of cooking container 1 is a non-magnetic body or a magnetic body, and is not limited to the above described configuration. For instance, voltage or current proportional to the magnitude of heating coil current IL such as voltage or current of resonance capacitor 4, current flowing to switching elements 7a, 7b, and current flowing to DC power supply 6 may be detected instead of heating coil current IL. Whether the magnetic body or the non-magnetic body may be detected using a magnet.

FIG. 4 is a diagram describing second material discriminating unit in the present exemplary embodiment. Second material discriminating unit 12 discriminates between iron and magnetic SUS when the material of cooking container 1 is discriminated as magnetic body in first material discriminating unit 11. Among the magnetic bodies, the iron and the magnetic SUS have different resistivity, where the iron generally has smaller resistivity. Thus, if the material of cooking container 1 is iron, heating output tends to become large compared to the case of the magnetic SUS, where ON time Ton of the switching element is shorter than with the magnetic SUS when obtaining the same heating output, and furthermore, heating coil current IL becomes large if ON time Ton of the switching element is the same.

Cooking container 1 having a pressure welding (high-press bonding) configuration exists as a heating body of the induction cooking device. Cooking container 1 having the pressure welding configuration refers to that in which the main body of cooking container 1 is formed from a non-magnetic body such as aluminum or copper, and a plate of magnetic SUS including a plurality of holes is joined to the outer side of the bottom surface portion of the main body of cooking container 1 by applying high pressure (same as above). In pressure bonding, a projecting portion projected towards the non-magnetic body side is cut into the main body of cooking container 1 at the periphery of each hole of the plate of the magnetic SUS, or a plurality of projections arranged at the bottom surface portion of the main body of cooking container 1 is passed through a plurality of holes of the plate of the magnetic SUS and the distal end of each projection is caulked by applying high pressure.

Therefore, when cooking container 1 is a pressure welding configuration, heating coil current IL becomes large if ON time Ton of the switching element is the same when obtaining the same heating output compared with the case of iron since the portion of the magnetic SUS and the portion of the non-magnetic body such as aluminum coexist at the bottom surface portion.

Such aspect is given attention in second material discriminating unit 12, and discrimination is made that the material is iron when the magnitude of heating coil current IL in which the heating output of inverter circuit 8 is a predetermined value (e.g., 1500 W) and ON time Ton of the switching element are within predetermined region as shown with a solid line in FIG. 4. In other words, in predetermined region 1, the magnitude of heating coil current IL is within a predetermined range with respect to ON time Ton of a predetermined switching element of smaller than or equal to Ton1. The material is discriminated as magnetic SUS when the magnitude of heating coil current IL and ON time Ton of the switching element are in region 2 that is not included in region 1. The reasons therefore will be described below.

For explanation, region 1 is divided into region 1a and region 1b, and region 2 is divided into three, region 2a, region 2b and region 2c. If the material is iron, a predetermined heating output is obtained at ON time Ton of the switching element of smaller than or equal to predetermined ON time Ton1 and at smaller than or equal to predetermined heating coil current IL compared to the case of magnetic SUS, and is distributed in the range of region 1a of FIG. 4. The value of region 1b is not obtained in the magnetic body, and the value of region 1b is obtained in the non-magnetic body, but the non-magnetic body is eliminated by first material discriminating unit 11. Second material discriminating unit 12 distinguishes between iron and magnetic SUS in the case of the magnetic body, and assumes region 1 as a combination of region 1a and region 1b.

When the material is magnetic SUS as described above, ON time Ton of the switching element is long compared to when the material is iron and thus is distributed to region 2a. When cooking container 1 has a pressure welding configuration, heating coil current IL for obtaining the same output increases by the effect of the non-magnetic body that partially exists in the bottom surface, and hence is distributed to region 2b and region 2c that indicates the intermediate properties of region 2b and region 2c of FIG. 4. In the present exemplary embodiment, region 1a and region 1b are assumed as region 1 all together, but substantially similar effects can be obtained even if only region 1a is assumed as region 1 and the others as region 1b.

When the temperature of cooking container 1 is controlled with infrared sensor 9, the magnetic SUS has lower emissivity than that of the iron and thus the temperature is controlled high when cooking container 1 is magnetic SUS than at the time of iron and overheating tends to occur. FIG. 5 is a diagram describing a set value of the control temperature changed according to the material of cooking container 1 in the present exemplary embodiment. Therefore, when second material discriminating unit 12 discriminates the material of cooking container 1 as magnetic SUS, control unit 10 sets the control temperature lower, as shown with line T2 of FIG. 5, than line T1 indicating the set value of the control temperature when the material is discriminated as iron. Thus, when second material discriminating unit 12 discriminates the material of cooking container 1 as magnetic SUS, control unit 10 shifts to an infrared sensor output correction mode of setting the control temperature low, and hence the bottom surface temperature of cooking container 1 can be controlled to a predetermined temperature at high accuracy similar as with iron even when the material of cooking container 1 is magnetic SUS.

### Second Exemplary Embodiment

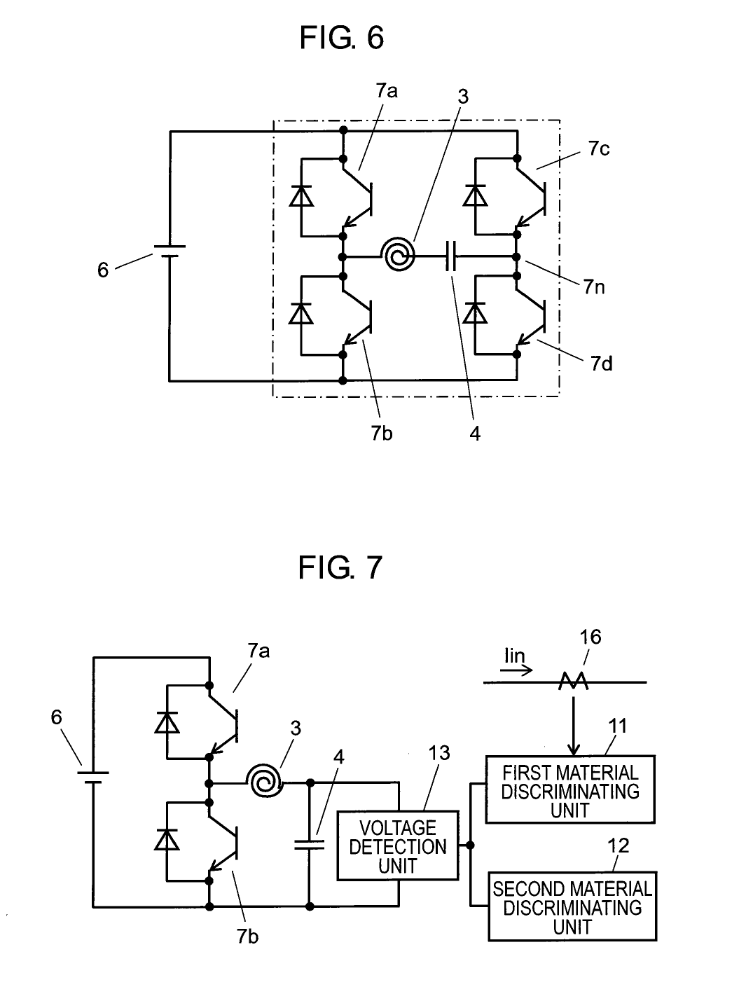

An induction cooking device according to a second exemplary embodiment of the present invention will now be described with reference to the drawings. FIG. 6 is a circuit diagram showing an inverter circuit of the induction cooking device according to the present exemplary embodiment. DC power supply 6 is shown as an equivalent circuit but is similar to DC power supply 6 of FIG. 2. The same reference numerals are used for the same portion as the first exemplary embodiment to omit the description thereof, and only the difference will be described.

The difference with the first exemplary embodiment lies in that inverter circuit 8 includes third switching element 7c on the high potential side and fourth switching element 7d on the low potential side, which are connected in series, and a series circuit connected to both ends of the series circuit including first switching element 7a and second switching element 7b is further arranged. The difference with the first exemplary embodiment further lies in that the other end of resonance circuit 5 is connected to connecting point 7n of third switching element 7c and fourth switching element 7d. In other words, the other end of resonance circuit 5 is connected to the high potential side of DC power supply 6 through third switching element 7c, and connected to the low potential side of DC power supply 6 through fourth switching element 7d. Moreover, the difference with the first exemplary embodiment also lies in that control unit 10 has a configuration of carrying out the control to cause first switching element 7a and fourth switching element 7d to become conduct simultaneously, and cause second switching element 7b and third switching element 7c to become conduct simultaneously.

According to such configuration, similar to the case of the half-bridge configuration of the first exemplary embodiment, first and fourth switching elements 7a, 7d and second and third switching elements 7b, 7b can be exclusively and alternately conducted, and the output can be controlled by the ON time of first and fourth switching elements 7a, 7d and second and third switching elements 7b, 7c even in the case of a full-bridge configuration including four switching elements 7a to 7d.

According to such configuration, the heating output of inverter circuit 8 can be increased and the temperature of cooking container 1 can be controlled to a predetermined temperature at high accuracy, similar to the case of iron, when the material of cooking container 1 is magnetic SUS or magnetic SUS pressure welded to the non-magnetic body, compared to the half-bridge configuration in which third switching element 7c and fourth switching element 7d are short-circuited as in the first exemplary embodiment.

### Third Exemplary Embodiment

A third exemplary embodiment of the present invention will now be described. The same reference numerals are used for the same portions as the first exemplary embodiment to omit the description, and only the difference will be described. The difference with the first exemplary embodiment lies in that the material of cooking container 1 is discriminated by measuring the magnitude of heating coil current IL, the magnitude of voltage or current applied on resonance capacitor 4 forming resonance circuit 5 with heating coil 3, or the magnitude of current flowing to first switching element 7a or second switching element 7b.

FIG. 7 shows a circuit diagram of an inverter circuit of an induction cooking device according to the present exemplary embodiment. In FIG. 7, DC power supply 6 is shown as an equivalent circuit but is similar to DC power supply 6 of FIG. 2. In FIG. 7, an input terminal of voltage detection unit 13 is connected to both ends of resonance capacitor 4 configuring resonance circuit 5. Voltage detection unit 13 measures the voltage applied on resonance capacitor 4. An electrical proportional relationship exists between the magnitude of heating coil current IL and the magnitude of the voltage applied on resonance capacitor 4. Using such relationship, first material discriminating unit 11 can compare the magnitude of input current Tin to inverter circuit 8 and the magnitude of the voltage applied on resonance capacitor 4 to discriminate the material of cooking container 1 between the non-magnetic body and the magnetic body.

Second material discriminating unit 12 compares the magnitude of the voltage applied on resonance capacitor 4 and ON time Ton of first switching element 7a or second switching element 7b to further discriminate the material of cooking container 1 discriminated as the magnetic body to magnetic SUS or iron.

A heating coil voltage detection unit for measuring the voltage applied on heating coil 3 may be arranged to measure the voltage applied on heating coil 3, and the magnitude of heating coil current IL can be measured using the electrical proportional relationship between the magnitude of heating coil current IL and the magnitude of the voltage applied on heating coil 3.

Furthermore, a switching element current detection unit for measuring the current flowing to first switching element 7a or second switching element 7b may be arranged to measure the magnitude of the current flowing to first switching element 7a or second switching element 7b, and the magnitude of heating coil current IL can be measured using the electrical proportional relationship between the magnitude of heating coil current IL and the magnitude of such currents.

Therefore, the material of cooking container 1 can be discriminated from the electrical proportional relationship of heating coil current IL and each measurement value instead of the heating coil current. This is the same in the case of the inverter circuit of the second exemplary embodiment.

### Fourth Exemplary Embodiment

A fourth exemplary embodiment of the present invention will now be described. The same reference numerals are used for the same portions as the first to third exemplary embodiments to omit the description, and only the difference will be described. The difference with the first to third exemplary embodiments lies in that operation unit 14 for the user to carry out setting is arranged, operation unit 14 including heating output setting portion 14a for setting the heating output in the heating mode, control temperature setting portion 14b for setting the control temperature in the temperature control mode, and control mode selecting portion 14c for selecting one control mode out of a plurality of control modes including the heating mode and the temperature control mode. The difference with the first to third exemplary embodiments also lies in that when control unit 10 heats cooking container 1 in the heating mode, the control temperature obtained when the material is discriminated as magnetic SUS is prohibited from being set lower than that obtained when the material is discriminated as iron from the determination result of first material discriminating unit 11 and second material discriminating unit 12.

In other words, in the present exemplary embodiment, control unit 10 includes the temperature control mode (also referred to as fry mode) that is the control mode for controlling the temperature of cooking container 1 to the control temperature set by the user, and the heating mode of heating cooking container 1 at the heating output set by the user. The difference with the first to third exemplary embodiments also lies in that the control temperature from about 160° C. to 200° C. as in the fry mode is not provided in the heating mode, and the control temperature of the temperature excessive rise preventing temperature (e.g., about 300°) for suppressing oil ignition is provided, and an accurate temperature control is not required, so that shift to the output correction mode of infrared sensor 9 is prohibited.

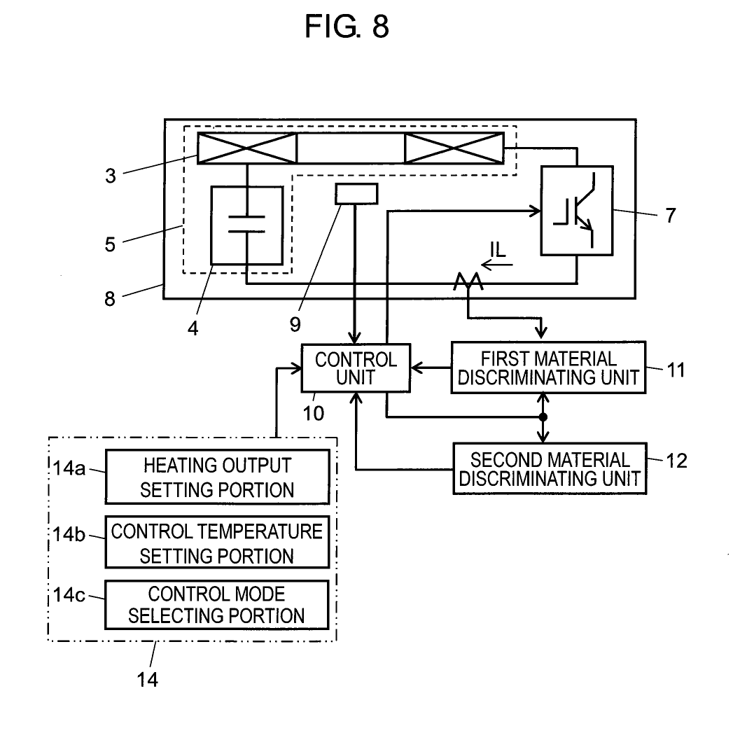

FIG. 8 is a configuration diagram showing the main parts of the induction cooking device according to the present exemplary embodiment. In FIG. 8, operation unit 14 is connected to control unit 10. Operation unit 14 includes heating output setting portion 14a, control temperature setting portion 14b, and control mode selecting portion 14c. In control mode selecting portion 14c, the user can selectively input the fry mode or the heating mode. When the user selects the heating mode with control mode selecting portion 14c, the temperature control with the control temperature obtained when the material is magnetic SUS being set lower than that obtained when the material is iron is prohibited. When the user selects the fry mode with control mode selecting portion 14c, control unit 10 operates first material discriminating unit 11 and second material discriminating unit 12 and shifts to the output correction mode according to the determination results.

According to such configuration, the material of cooking container 1 of the magnetic body is discriminated only when carrying out cooking that requires highly accurate temperature adjustment as in the fry mode, which prevents second material discriminating unit 12 from falsely operating to needlessly lower the temperature excessive rise preventing function, in the case of cooking where the state of cooking container 1 tends to change greatly as in the heating mode.

### Fifth Exemplary Embodiment

A fifth exemplary embodiment of the present invention will now be described. The same reference numerals are used for the same portion as the first exemplary embodiment to omit the description thereof, and only the difference will be described. The difference with the first exemplary embodiment lies in that control unit 10 carries out the discrimination of second material discriminating unit 12 after elapse of a predetermined time from the start of heating. In other words, the values of ON time Ton and heating coil current IL are not defined immediately after control unit 10 shifts to fry mode. Thus, second material discriminating unit 12 carries out the discrimination after elapse of a predetermined time (e.g., 30 seconds) in which the relationship of ON time Ton and heating coil current IL is substantially stabilized after shift to the fry mode in an aim to prevent false discrimination.

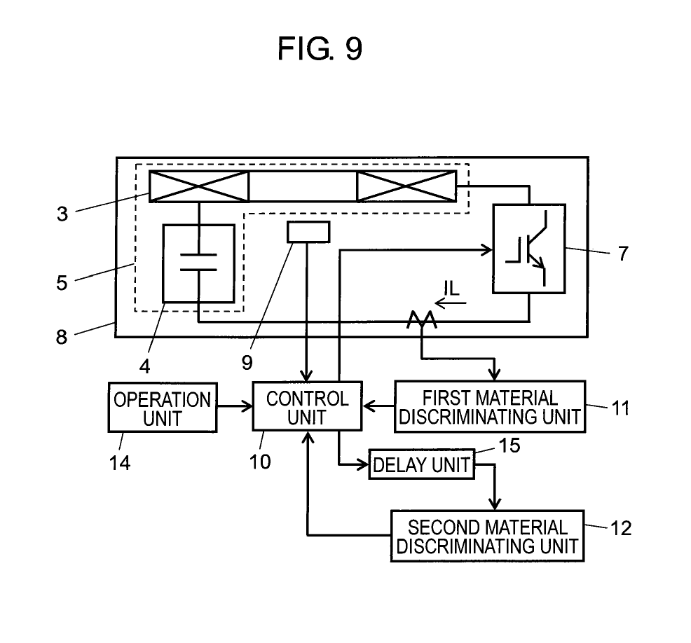

FIG. 9 is a configuration diagram of the main parts of the induction cooking device in the present exemplary embodiment. In FIG. 9, second material discriminating unit 12 is connected to control unit 10 through delay unit 15. Operation unit 14 described in the fourth exemplary embodiment is also connected to control unit 10. Therefore, when the user selects the fry mode of controlling the temperature of cooking container 1 to a predetermined control temperature at high accuracy with operation unit 14 and starts heating, control unit 10 transmits a count start signal to delay unit 15, and delay unit 15 operates second material discriminating unit 12 with a delay of a predetermined time. Thus, second material discriminating unit 12 discriminates the material of cooking container 1 after the relationship of ON time Ton and heating coil current IL is substantially stabilized. According to such configuration, the material of cooking container 1 can be stably discriminated.

When the user selects the heating mode instead of the fry mode with operation unit 14, control unit 10 substantially does not carry out the operation based on the determination result of second material discriminating unit 12.

In the present exemplary embodiment, the discrimination of second material discriminating unit 12 is carried out after elapse of a predetermined time using delay unit 15, but any method can be adopted as long as the discriminating operation by second material discriminating unit 12 can be delayed from the start of the heating operation without using delay unit 15.

The configurations of the first to fifth exemplary embodiments may be appropriately combined for use.

As described above, the present invention includes an inverter circuit, including a heating coil for inductively heating a cooking container, a resonance capacitor for configuring a resonance circuit with the heating coil, and a switching element, for supplying a heating coil current corresponding to an ON time of the switching element to the heating coil. An infrared sensor for detecting infrared light radiated from the bottom surface of the cooking container, a first material discriminating unit for discriminating the material of the cooking container between a non-magnetic body and a magnetic body, a second material discriminating unit for discriminating the material of the cooking container between magnetic SUS and iron, and a control unit for controlling the magnitude of the output of the inverter circuit by changing the ON time of the switching element to carry out the control such that the detection temperature of the infrared sensor becomes a predetermined control temperature, and setting the control temperature lower when the material is discriminated as magnetic SUS than when the material is discriminated as iron based on the determination result of the first material discriminating unit and the second material discriminating unit. Furthermore, the second material discriminating unit compares the magnitude of the heating coil current and the ON time of the switching element in a case where the heating output is set to a predetermined value, and discriminates the material of the cooking container as iron if the magnitude of the heating coil current is within a predetermined region with respect to the ON time of the switching element and discriminates the material of the cooking container as magnetic SUS if the ON time of the switching element and the magnitude of the heating coil current are outside the predetermined region. According to such configuration, the material can be appropriately discriminated to magnetic SUS and iron, or to magnetic SUS including the magnetic SUS pressure welded to the non-magnetic body and iron when the material of the cooking container is a magnetic body, and the temperature of the cooking container can be controlled to a predetermined temperature at high accuracy similar to the case of iron when the material of the cooking container is magnetic SUS or magnetic SUS pressure welded to the non-magnetic body.

In the present invention, the second material discriminating unit discriminates the material of the cooking container as iron when the ON time of the switching element is smaller than a first predetermined value, and discriminates the material of the cooking container as magnetic SUS when the ON time of the switching element is greater than or equal to a first predetermined value. According to such configuration, discrimination can be appropriately made to magnetic SUS and iron when the material of the cooking container is a magnetic body, and the influence of the difference in reflectivity can be alleviated and the temperature of the cooking container can be controlled to a predetermined temperature at high accuracy, similar to the case of iron, even when the material of the cooking container is magnetic SUS.

Furthermore, in the present invention, the second material discriminating unit discriminates the material of the cooking container as iron when the ON time of the switching element is smaller than a first predetermined value and the heating coil current is smaller than a second predetermined value, and discriminates the material of the cooking container as magnetic SUS in other cases. According to such configuration, discrimination can be appropriately made to magnetic SUS including magnetic SUS pressure welded with the non-magnetic body and iron when the material of the cooking container is a magnetic body, and the influence of the difference in reflectivity can be alleviated and the temperature of the cooking container can be controlled to a predetermined temperature at high accuracy, similar to the case of iron, even when the material of the cooking container is either magnetic SUS or magnetic SUS pressure welded with the non-magnetic body.

In the present invention, the inverter circuit includes a series circuit including a first switching element on a high potential side and a second switching element on a low potential side, which are connected in series. Furthermore, one end of the resonance circuit is connected to a connecting point of the first switching element and the second switching element, and the other end of the resonance circuit is connected to the low potential side of the second switching element or the high potential side of the first switching element. Moreover, the control unit causes the first switching element and the second switching element to become conductive exclusively and alternately and controls the output of the inverter circuit by the ON time of the first switching element and the second switching element to control the output such that the temperature obtained from the infrared sensor becomes a predetermined control temperature. The second material discriminating unit discriminates the material as iron when the heating coil current and the ON time of the switching element are within a predetermined region, and discriminates the material as magnetic SUS when the heating coil current and the ON time of the switching element are not within the region. According to such configuration, the material can be appropriately discriminated between magnetic SUS and iron, or between magnetic SUS pressure welded to the non-magnetic body and iron when the material of the cooking container is the magnetic body, and the temperature of the cooking container can be controlled to a predetermined temperature at high accuracy, similar to the case of iron, when the material of the cooking container is magnetic SUS or magnetic SUS pressure welded to the non-magnetic body.

In the present invention, the inverter circuit includes a series circuit including a first switching element on a high potential side and a second switching element on the low potential side, which are connected in series, and a series circuit including a third switching element on the high potential side and a fourth switching element on a low potential side, which are connected in series, and being connected to both ends of the series circuit including the first switching element and the second switching element. Furthermore, one end of the resonance circuit is connected to a connecting point of the first switching element and the second switching element, and the other end of the resonance circuit is connected to the connecting point of the third switching element on the high potential side and the fourth switching element. Moreover, the control unit causes the first switching element and the fourth switching element to become conductive simultaneously and causes the second switching element and the third switching element to become conductive simultaneously. According to such configuration, the heating output of the inverter circuit can be made large compared to the half-bridge configuration in which the third switching element and the fourth switching element are short-circuited, and the temperature of the cooking container can be controlled to a predetermined temperature at high accuracy, similar to the case of iron, when the material of the cooking container is magnetic SUS or magnetic SUS pressure welded to the non-magnetic body.

In the present invention, the second material discriminating unit obtains a magnitude of the heating coil current by measuring any of a magnitude of a voltage applied to the heating coil or the resonance capacitor, and a magnitude of a current flowing to the first switching element or the second switching element. According to such configuration, the second material discriminating unit can discriminate the material between magnetic SUS and iron when the material of the cooking container is a magnetic body without directly measuring the heating coil current.

The present invention also includes an operation unit for the user to set the heating output and the control temperature; and a control mode selecting portion for selecting one control mode from a plurality of control modes including a heating mode of heating at the heating output set with the operation unit and a temperature control mode of controlling such that the detection temperature of the infrared sensor becomes the control temperature set with the operation unit. When selecting the heating mode with the control mode selecting portion and heating the cooking container, the control unit prohibits the control temperature obtained when the material is discriminated as magnetic SUS from being set lower than that obtained when the material is discriminated as iron from the determination result of the first material discriminating unit and the second material discriminating unit. According to such configuration, the material of the cooking container of the magnetic body is discriminated only when operating in the control mode that requires a highly accurate temperature adjustment depending on the cooking method, and prevents false operation and the control temperature from becoming needlessly low thus lowering the cooking performance when operating in the heating mode.

In the present invention, the control unit causes the second material discriminating unit to carry out discrimination after elapse of a predetermined time from the start of the heating operation. According to such configuration, the material of the cooking container can be stably discriminated.

### INDUSTRIAL APPLICABILITY

Therefore, the induction cooking device according to the present invention can appropriately discriminate the material of the cooking container between that using magnetic SUS and that using iron, where the temperature of the cooking container can be controlled to a predetermined temperature at high accuracy using the infrared sensor even in the case of the cooking container using magnetic SUS. Therefore, it is useful in the induction cooking device where it is important to maintain the temperature of the object to be cooked accommodated in the cooking container at a predetermined temperature at high accuracy such as fried food cooking.

### REFERENCE MARKS IN THE DRAWINGS

1 cooking container

2 top plate

3 heating coil

4 resonance capacitor

5 resonance circuit

6 DC power supply

7 switching element section

7a first switching element

7b second switching element

7c third switching element

7d fourth switching element

8 inverter circuit

9 infrared sensor

10 control unit

11 first material discriminating unit

12 second material discriminating unit

13 voltage detection unit

14 operation unit

15 delay unit

16 current transformer (input current detection unit)

17 current transformer (heating coil current detection unit)

18 commercial power supply

1. An induction cooking device comprising:
an inverter circuit, including a heating coil for inductively heating a cooking container, a resonance capacitor configuring a resonance circuit with the heating coil, and a switching element, for supplying a heating coil current corresponding to an ON time of the switching element to the heating coil;
an infrared sensor for detecting infrared light radiated from a bottom surface of the cooking container;
a first material discriminating unit for discriminating a material of the cooking container between a non-magnetic body and a magnetic body;
a second material discriminating unit for discriminating the material of the cooking container between magnetic SUS and iron; and
a control unit for controlling a magnitude of an output of the inverter circuit by changing the ON time of the switching element to carry out a control so that a detection temperature of the infrared sensor becomes a predetermined control temperature, and setting the control temperature lower when the material is discriminated as magnetic SUS than when the material is discriminated as iron based on determination results of the first material discriminating unit and the second material discriminating unit, wherein
the second material discriminating unit compares a magnitude of the heating coil current and the ON time of the switching element in a case where a heating output is set to a predetermined value, and discriminates the material of the cooking container as iron if the ON time of the switching element and the magnitude of the heating coil current are within a predetermined region and discriminates the material of the cooking container as magnetic SUS if the ON time of the switching element and the magnitude of the heating coil current are outside the predetermined region.

2. The induction cooking device according to claim 1, wherein the second material discriminating unit discriminates the material of the cooking container as iron when the ON time of the switching element is smaller than a first predetermined value, and discriminates the material of the cooking container as magnetic SUS when the ON time of the switching element is greater than or equal to the first predetermined value.

3. The induction cooking device according to claim 2, wherein the material of the cooking container is discriminated as iron when the heating coil current is smaller than a second predetermined value, and the material of the cooking container as magnetic SUS when the heating coil current is greater than or equal to the second predetermined value.

4. The induction cooking device according to claim 1, wherein
the inverter circuit includes a series circuit including a first switching element on a high potential side and a second switching element on a low potential side, which are connected in series, one end of the resonance circuit being connected to a connecting point of the first switching element and the second switching element, and the other end of the resonance circuit being connected to the low potential side of the second switching element or the high potential side of the first switching element;
the control unit causes the first switching element and the second switching element to become conductive exclusively and alternately and controls an output of the inverter circuit by the ON time of the first switching element and the second switching element to control the output such that a detection temperature of the infrared sensor becomes a predetermined control temperature; and
the second material discriminating unit discriminates the material as iron when the heating coil current and the ON time of the switching element are within a predetermined region, and discriminates the material as magnetic SUS when the heating coil current and the ON time of the switching element are not within the region.

5. The induction cooking device according to claim 1, wherein the inverter circuit includes a series circuit including a first switching element on a high potential side and a second switching element on a low potential side, which are connected in series, and a series circuit including a third switching element on the high potential side and a fourth switching element on the low potential side, which are connected in series, and being connected to both ends of the series circuit including the first switching element and the second switching element, one end of the resonance circuit being connected to a connecting point of the first switching element and the second switching element, and the other end of the resonance circuit being connected to a connecting point of the third switching element and the fourth switching element, and the control unit causes the first switching element and the fourth switching element to become conductive simultaneously, and causes the second switching element and the third switching element to become conductive simultaneously.

6. The induction cooking device according to claim 1, wherein the second material discriminating unit obtains a magnitude of the heating coil current by measuring any of a magnitude of a voltage applied to the heating coil or the resonance capacitor, and a magnitude of a current flowing to the first switching element or the second switching element.

7. The induction cooking device according to claim 1 further comprising:
an operation unit for a user to set a heating output and the control temperature; and
a control mode selecting portion for selecting one control mode from a plurality of control modes including a heating mode of heating at the heating output set with the operation unit and a temperature control mode of controlling such that a detection temperature of the infrared sensor becomes the control temperature set with the operation unit; wherein
when selecting the heating mode with the control mode selecting portion and heating the cooking container, the control unit prohibits the control temperature from being set low when the material is discriminated as magnetic SUS than when the material is discriminated as iron from determination results of the first material discriminating unit and the second material discriminating unit.

8. The induction cooking device according to claim 1, wherein the control unit causes the second material discriminating unit to carry out discrimination after elapse of a predetermined time from the start of the heating operation.
